(19) United States
(12) Patent Application Publication
(10) Pub. No.: US 2023/0333657 A1
(43) Pub. Date: Oct. 19, 2023

(54) SYSTEMS, METHODS, AND COMPUTER READABLE MEDIA TO CONVERT AUDIO/SPATIAL INFORMATION TO MULTIDIMENSIONAL HAPTIC FEEDBACK

(71) Applicant: James Joseph Mullis, Plant City, FL (US)

(72) Inventor: James Joseph Mullis, Plant City, FL (US)

(21) Appl. No.: 18/118,128

(22) Filed: Mar. 6, 2023

Related U.S. Application Data
(60) Provisional application No. 63/316,673, filed on Mar. 4, 2022.

(51) Int. Cl. G06F 3/16; G06F 3/01

(52) U.S. Cl. CPC G06F 3/016; G06F 3/011; G06F 3/16

(57) ABSTRACT

Systems, methods, and computer readable media to convert audio/spatial information to multidimensional haptic feedback, are described.

### TECHNICAL FIELD

Embodiments relate generally to electronic perception enhancement systems, and more particularly, to systems, methods, and computer readable media to convert audio/spatial information to multidimensional haptic feedback.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a block diagram of a system in accordance with some implementations.

FIG. 2 is a flowchart showing an example method in accordance with some implementations.

FIG. 3 shows a block diagram of a system in accordance with some implementations.

FIG. 4 is a flowchart showing an example method in accordance with some implementations.

FIG. 5 shows a block diagram of a system in accordance with some implementations.

FIG. 6 is a flowchart showing an example method in accordance with some implementations.

FIG. 7 shows a block diagram of a system in accordance with some implementations.

FIG. 8 is a flowchart showing an example method in accordance with some implementations.

FIG. 9 shows a block diagram of a system in accordance with some implementations.

FIG. 10 is a flowchart showing an example method in accordance with some implementations.

FIG. 11 shows a block diagram of a system in accordance with some implementations.

FIG. 12 is a flowchart showing an example method in accordance with some implementations.

FIG. 13 shows a block diagram of a system in accordance with some implementations.

FIG. 14 is a flowchart showing an example method in accordance with some implementations.

### DETAILED DESCRIPTION

Before getting into details about the disclosed subject matter we will examine the potential users of such a system and their accompanying challenges that the disclosed subject matter addresses. To begin, let us define the not so common terms “haptic” and a term known as “synesthesia” to assist in explaining the concept of the disclosed subject matter.

So, what does “haptic” mean? The online Merriam-Webster dictionary defines haptic as “1: relating to or based on the sense of touch”. A haptic feedback device allows its wearer to receive tactile information through one’s sensations. The disclosed subject matter presented has to do with interacting with the human sense of touch and typically, but not limited to, the human skin. As will be revealed, it will be used to communicate a spatial environment to the user by using their sense of touch and the brain’s ability to perceive that environment as a two- or three-dimensional space.

The disclosed subject matter can communicate audio and spatial information or the like into “touch points” and send it to one or more haptic feedback devices, for example, a haptic feedback glove. A touch point may include, but is not limited to, location in two- or three-dimensional space, intensity, velocity, temperature, and/or the frequency at which it pulsates. These touch points are typically realized using miniature actuators or some other controllable means of tactile stimulation by the receiving haptic device. These sensations are processed and interpreted by the human brain and organized into discernable perception relative to the sourced environment. The larger the area covered, as well as the more concentrated the touch points, the more accurate the user’s interpretation will be against that area of skin or tissue.

Wikipedia defines “Synesthesia” (US English) or “Synaesthesia” (British English) as “a perceptual phenomenon in which stimulation of one sensory or cognitive pathway leads to involuntary experiences in a second sensory or cognitive pathway.” In other words, it is a human condition in which the brain can map one sense to another. For example, some people can “hear” what something smells like. Some can “taste” the colors they see. Others perceive numbers in a spatial way. Similarly, the disclosed subject matter directly maps external source information, such as, but not limited to, sight and sound, to the human sense of touch, thus enabling its user to gain a more robust perception and awareness of the source environment.

With those terms and concepts defined, let us now describe the problems for whom and to what the disclosed subject matter solves. The blind and sight-compromised face daily challenges functioning in the everyday world. A world in which most people do not give a second thought. The sight-gifted can move about freely and effortlessly. They make simple navigation decisions to optimize their walking journeys safely. These individuals easily make decisions to avoid imminent dangers based on what they see, hear, and smell. There do exist in today’s world a range of prosthetics to help those with sight impairments, from a simple cane to more elaborate technologies that can give feedback to their wearer to assist with common tasks. Unfortunately, these existing technologies give feedback that is extremely limited and binary in scope. They typically only have an exceedingly small detection point, for example the tip of a cane. More advanced devices are limited in the manners in which they communicate with their user. For example, most electronic devices today involve simple sounds or single touch points on an arm or leg. Many devices require focusing on the immediate environment in front of a person or require that person to interactively instruct the device what to “look” for. Even more complex devices typically have a narrow field of observation, require considerable computing power, and are composed of many lines of programming to derive intelligence from the observed data that reduces only to simple momentary indicators, such as beeps, varying tones, saying an audible word, or vibrating in a hand or on an arm or leg. The human brain has incredible computing power with advanced pattern matching capabilities. Much of this capability is dedicated to interpreting the environment around us. The brain can pull a friend’s voice out of a noisy restaurant dining room to that of seeing obstacles through the rain. The brain has the immediate capacity to filter “noise” from sight, sound, taste, smell, and touch. It easily discards, in a blink, stimuli deemed irrelevant or non-critical for cognitive assessment; it can filter and focus. The brain does this naturally. It does what takes a computer CPU billions of cycles and hundreds of thousands of lines of computer code to accomplish. Rather than A.I. (Artificial Intelligence), the brain uses O.I. (Organic Intelligence).

What if we could map some of these senses, such as sight and sound, to the sensation of touch? Sight is derived from a flat surface in the form of a retina in our eyes where then our brains derive a perspective context of our environment based on that detected visible light. Sounds strike an ear drum membrane in our ears causing it to vibrate where our brains pick up these sensations and extract frequencies and timbres into meaningful patterns for speech and music. Having two eyes and two ears give us directionality, too. They allow us to mentally build a perspective of our surroundings.

What if we could map visible light to an area on the largest organ of the human body, namely our skin? We could then “see” through the sensation of touch and dynamically “feel” the proximity of objects. Imagine a blind person being able to hold the palms of their hands in front of themselves and feel objects at a distance or read the floors in braille of an elevator. This is one of the most important things the disclosed subject matter performs. It allows us to “feel” objects and patterns at a distance.

A key feature of the disclosed subject matter allows for the variation in the sensitivity regarding the distance of objects. Our hands, fingers, and palms normally function in a binary mode; you are either touching something physical or you are not. However, touch has pressure sensitivity. What if this pressure sensitivity could be calibrated for objects at a distance instead of direct contact? The disclosed subject matter does exactly that using pressure and frequency of vibration. Objects closer to the user vibrate touch points at a high frequency, those farther away a lower frequency.

The disclosed subject matter allows the brain to do what it does best: interpreting sensory input and discerning patterns. We know the brain can map touch to letters and numbers in the form of braille devices on elevator pads and braille computer keyboards. The brain’s job is to map sight, sound, and other types of input into a cognitive environment perceived by our mind to allow us to interact with the universe around us. The disclosed subject matter allows for these dynamic external stimuli to communicate with our brains using our sense of touch. These stimuli include, but are not limited to, data from cameras, microphones, measurement instrumentation, data collections, sensors, and telemetry.

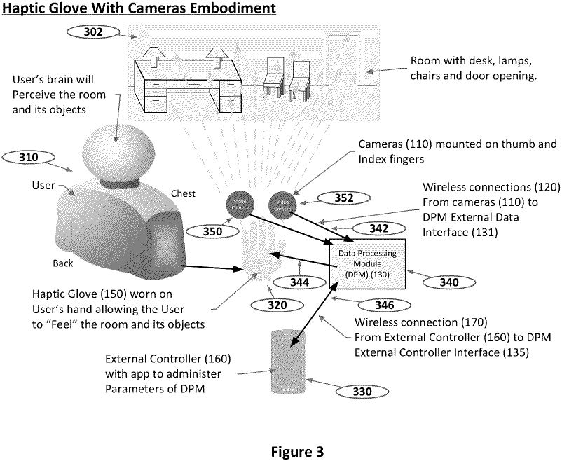

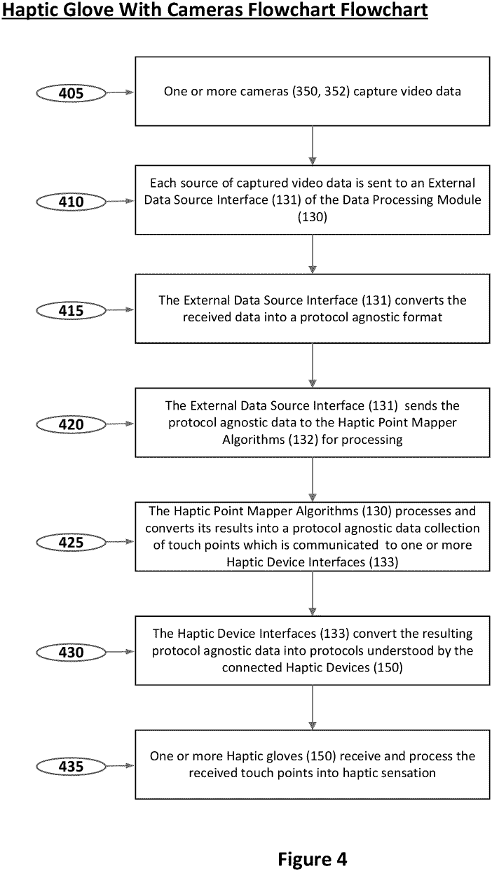

As previously mentioned, one of the implementations of the disclosed subject matter (FIGS. 3 and 4) includes, but is not limited to, mapping visible light from one or more cameras to a collection of cutaneous actuators on a glove allowing a sight-challenged individual the ability to “feel” their surroundings in real-time or near real-time using a haptic feedback glove. But why stop with visible? The cameras could be instantly switched to non-visible light, such as infrared and ultraviolet spectrums, to name a couple. Various frequencies of electromagnet waves, for example Radio Frequencies, also known as R.F., could also be detected by the disclosed subject matter and mapped to the glove. As the user would move their hands around, they could feel the location and intensity of these sources. The disclosed subject matter allows for adjusting the sensitivity, filtering, enhancement, and transposing of the detected data to suit the wearer’s points of interest using a controller.

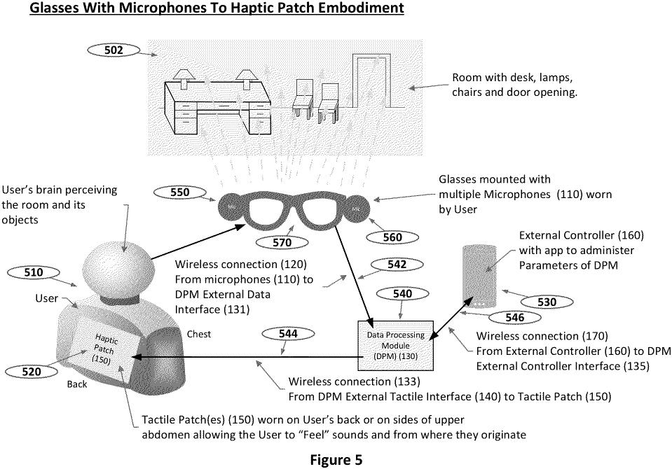

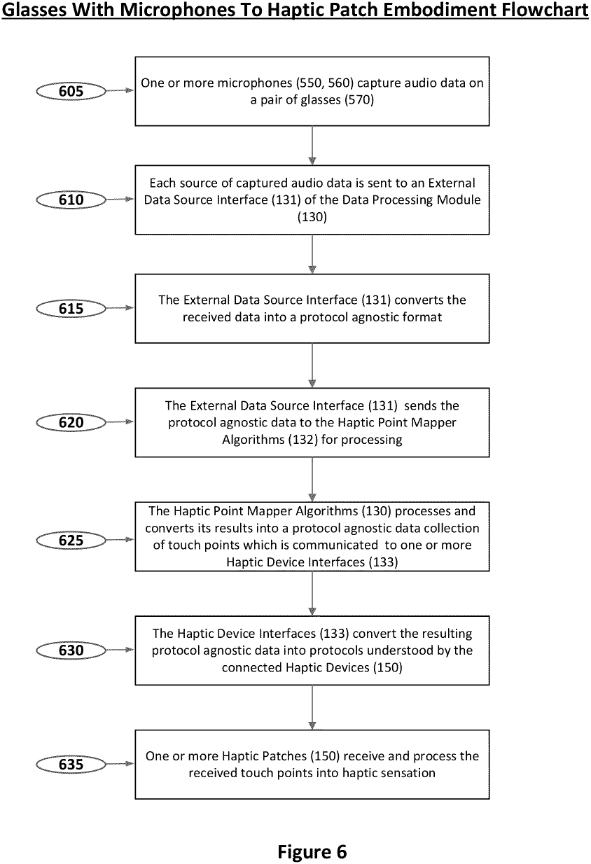

Another implementation of the disclosed subject matter involves a pair of glasses outfitted with two or more audio sensors mapped to a multitude of cutaneous actuators worn as a patch on an individual’s back (FIGS. 5 and 6). This could allow a hearing-impaired user to determine from which direction certain sounds, or the calling of the user’s name, was originating, as well as from how far away. Additionally, the spoken words could be processed and communicated to the haptic patch thereby increasing the user’s lip-reading accuracy. This allows a new capability for the user to “hear” what is being spoken.

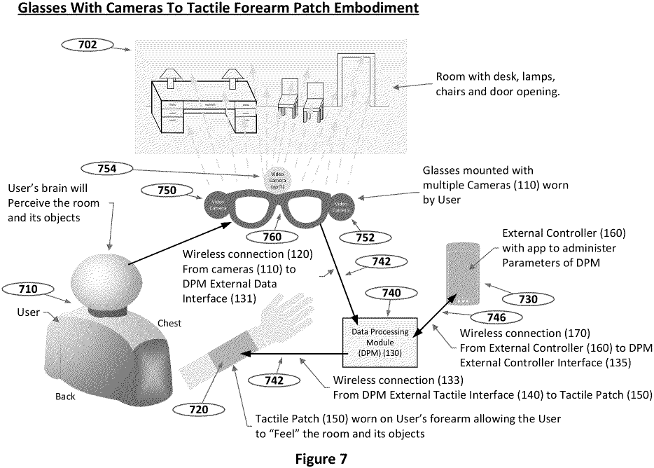

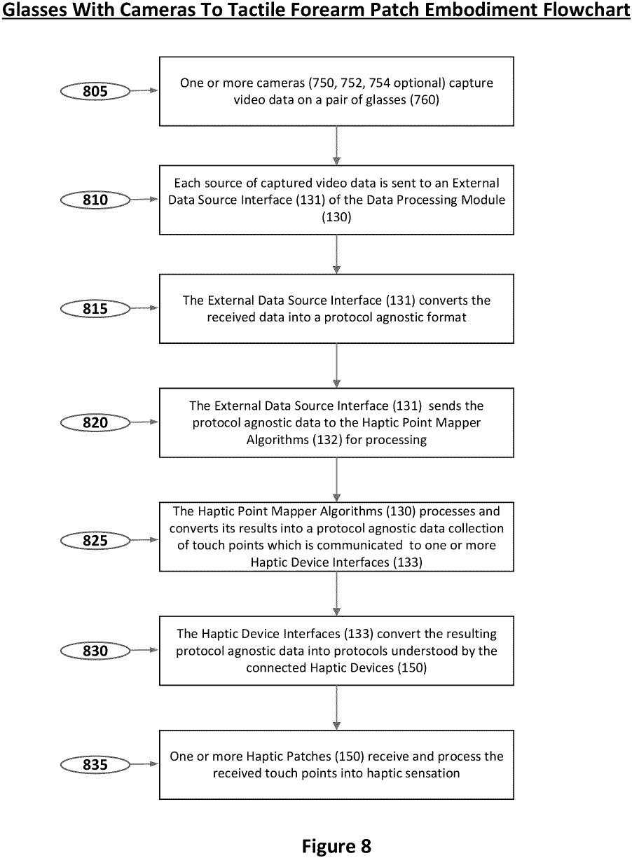

A simple implementation of the disclosed subject matter would strap a haptic patch on the user’s forearm (FIGS. 7 and 8). This would allow a glasses/forearm patch combination that could be quite portable.

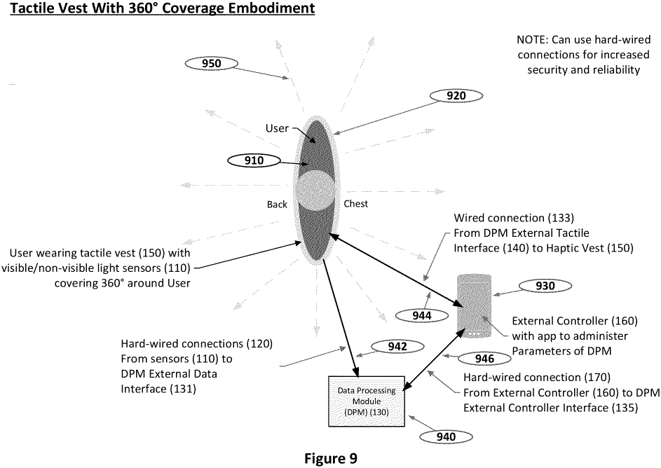

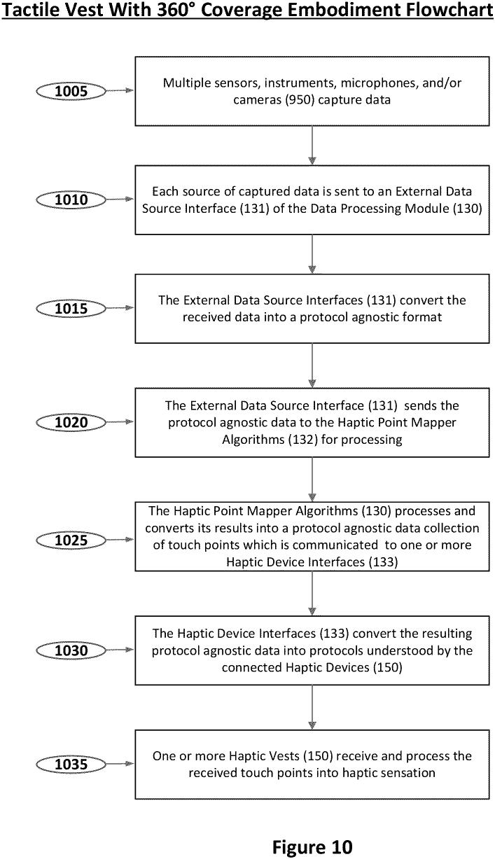

Other implementations of the disclosed subject matter could involve mapping camera, radar, lidar, or ultrasonic sensors to an entire vest (FIGS. 9 and 10) made of a plurality of cutaneous actuators that could help large ship and aircraft pilots “feel” all craft and structures around them during critical navigation. EMS, search, and rescue could also use the vest implementation to help locate the missing, injured, or submerged in addition to keeping track of fellow team members. Military and law enforcement would have a new tool to enhance their operating effectiveness. “Seeing” in the dark, touch based communication, locating radio transmissions, and locating movement or origin of gunshots are a few benefits that could compliment their existing tools.

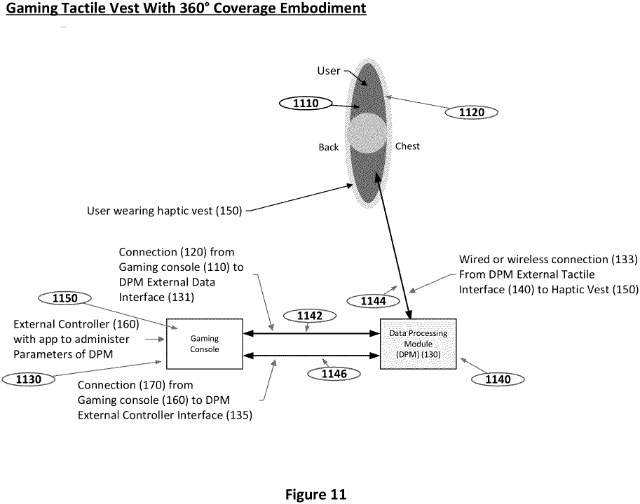

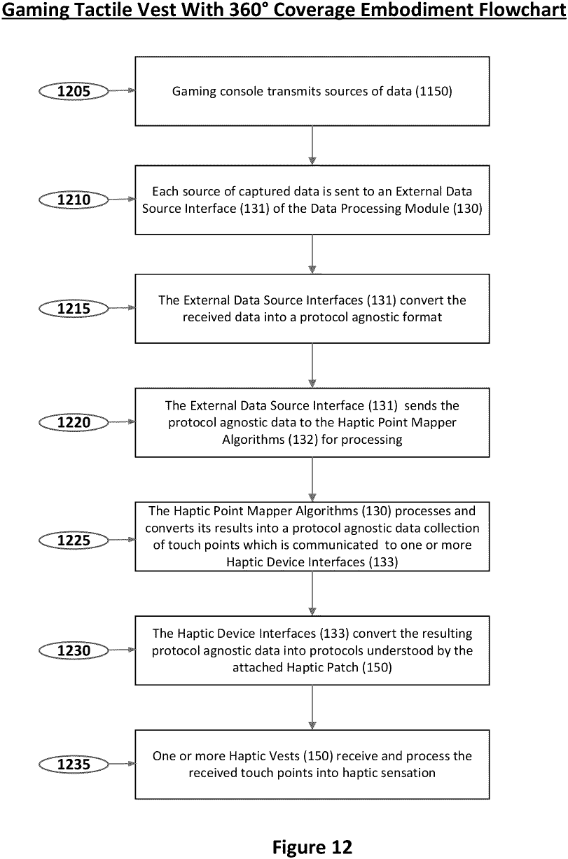

A gaming system data source implementation (FIGS. 11 and 12) would allow a more immersive experience as well as in game communication between players. Blind and deaf players could now experience previously impossible play with “video” games.

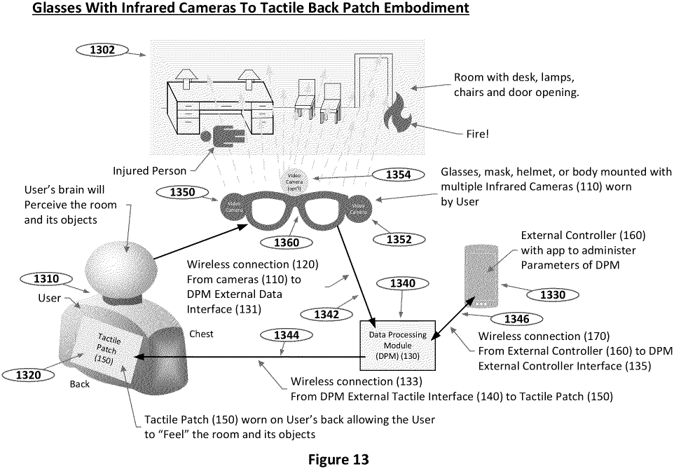

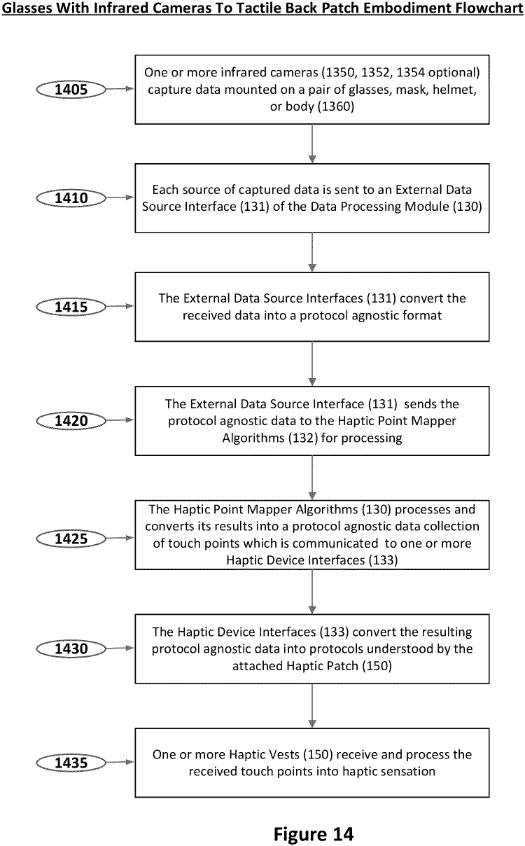

Fire departments could use a glasses, face mask, helmet, or body mounted implementation (FIGS. 13 and 14) that could help identify fallen victims or fire sources.

Certain implementations of the disclosed subject matter include, but are not limited to, infrared light or Geiger counter source data being mapped to a plurality of cutaneous actuators in the form of a haptic patch worn on an individual’s back. This could map heat signatures or radioactive material sources in real-time or near real-time in a non-intrusive way.

By far the biggest beneficiaries of the disclosed subject matter are the deaf and blind. It allows them to go from a disability to super-abilities in which they can “hear” and “see” things using their skin that no human is naturally capable of. The vest or girdle implementation would allow them job opportunities that do not yet exist. They could participate more fully with the workforce. They could “feel” their environment from all around and filter and tune into the types of non-visible, un-hearable, and un-touchable information in ways that could benefit society at large. They would effectively “see” and “hear” their environment. This benefits for this new ability for those deprived of sight and sound cannot be overstated.

The usefulness of the disclosed subject matter is made possible by the brain’s ability to associate patterns into conscious perception. We typically do not notice the blind spots in our eyes, or the fact that everything we are seeing is inverted. Our brains take in this input and organize it into a practical understanding of the environment around us. It effortlessly triangulates depth and location, it fills in distance measurements germane to our culture and language, maps light into simple shapes we call boxes and circles and squares to even more complex objects like people, cars, chairs, and textures. Rather than processing input from a retina or ear drum, the brain can also infer a complementary capability through our sense of touch. How It Works

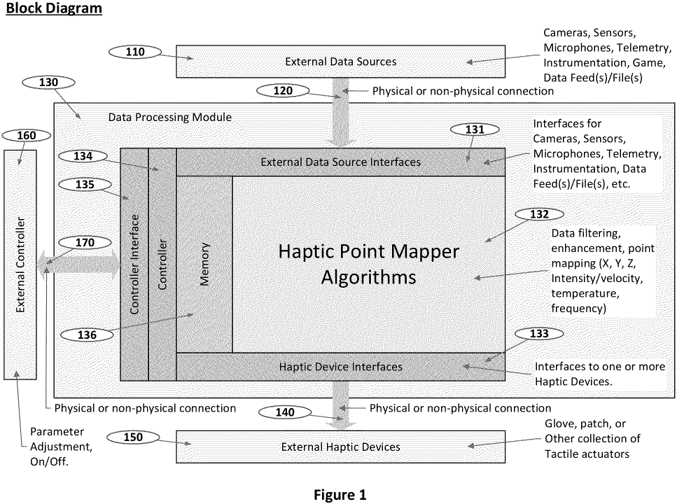

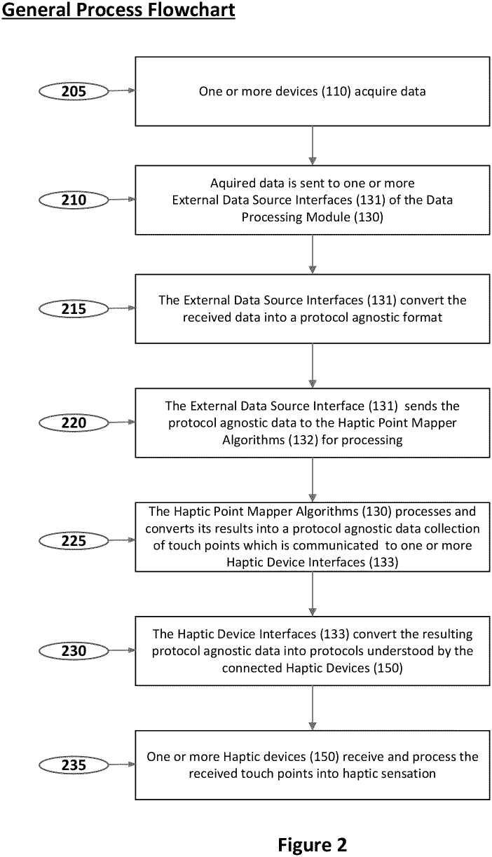

Please refer to the Block Diagram (FIG. 1) and General Process Flowchart (FIG. 2) for the following discussion. Data originates from one or more External Data Sources (110) and transmitted via either a physical or non-physical medium (120) into the Data Processing Module (130) via one or more External Data Source Interfaces (131). This data can originate from a source such as, but not limited to, one or more cameras, sensors, and/or microphones or the like. The External Data Source Interfaces (131) convert data into a protocol agnostic format understood by the Haptic Point Mapper Algorithms (132) which transform the protocol agnostic data into individual, contextual mapping points where each point has X, Y, and optionally Z vector points that map into a two- or optionally three-dimensional space, and optionally temperature, amplitude, velocity, and one or more pulse frequencies or the like for each point to further refine and enhance the experience. The resulting mapped points are then communicated through one or more Haptic Device Interfaces (133) over either physical or non-physical mediums (140) to one or more External Haptic Devices (150), such as, but not limited to, a haptic glove, patch, or vest, which is in contact with the user’s skin or cornea(s).

For example, an object distance value in the protocol agnostic data can be transformed into a pattern of haptic touch points including location designations on the receiving haptic device, temperature, pulse pattern, and vibration frequency. The Haptic Point Mapper Algorithms can also refine the user’s contextual subjects of interest for improved sensation on the haptic device(s), like identifying individual human beings in a room using infrared to complement visible light images. This allows someone in a restaurant to move about but also determine where people are sitting or standing. It becomes second nature for the user to direct their attention when moving about or interacting in such a setting. Multiple frequencies can be used to communicate additional proximity information to complement the edges of detected objects, such as, but not limited to, a varying lower frequency component indicating the near-ness and far-ness of detected information.

If an implementation of the disclosed subject matter were to map two data sources, such as, but not limited to, two cameras on a pair of glasses and each camera were to be mapped to two separate haptic devices worn on the back, or just split/mapped to the left and right side of a single haptic device, the user’s brain would map the three-dimensional nature of camera images into a perceived three-dimensional space just like our two eyes using our retinas but instead using our skin. Additionally, if an implementation used two microphones on a pair of glasses, their source data could be mapped to two separate haptic devices worn on both sides of our upper abdomen, the user’s brain would map the three-dimensional nature of the sounds detected into a perceived three-dimensional space just like our ears but instead using our skin as the receptors. The algorithms can also enhance the mapping points sent to each individual haptic device by examining input from all source devices and not just performing a one-to-one mapping. This improves things like object and edge detection and provides a more enhanced user experience. Additionally, this improves the detection of see-through objects, such as, but not limited to, glass. It allows for the user to have a pair of worn glasses with video cameras and ultrasonic distance measuring devices to detect both a large glass window as well as the objects viewable on the other side.

An External Controller (160) connected over either a physical or non-physical medium (170) allows the user to configure parameters of the Data Processing Module (130) algorithms such as, but not limited to, on/off, sensitivity, filtering, and data enhancement/conditioning. The resulting process will allow the user to realize and “feel” the data from the data source environment.

Areas of the attached haptic devices can also be dedicated to map some controller information, such as, but not limited to, indicating which source devices are active or sensitivity levels. Algorithm indicators may also send information to one of these areas indicating additional dynamic metrics such as, but not limited to, focus depth or battery levels.

A computing device to implement the disclosed subject matter includes one or more processors, nontransitory computer readable medium and network interface. The computer readable medium can include an operating system, an application and a data section.

In operation, the processor may execute the application stored in the computer readable medium. The application can include software instructions that, when executed by the processor, cause the processor to perform operations to control electric vehicle charging station power in accordance with the present disclosure (e.g., performing associated functions described above).

The application program can operate in conjunction with the data section and the operating system.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multicore, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, systems, methods, and computer readable media to convert audio/spatial information to multidimensional haptic feedback.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A system for converting a plurality of external data points into a projected haptic image applied against human skin, wherein the system can apply a plurality of algorithms to assist in the transposition of the external data points, and wherein resulting pixels of the projected haptic image employ one or more of frequency, amplitude, or temperature.

2. The system of claim 1, wherein the system is configured to capture visible light images to assist a user in mentally perceiving an environment.

3. The system of claim 1, wherein the system is configured to capture non-visible light images to assist a user in mentally perceiving an environment.

4. The system of claim 1, wherein one or more of the external data points originate from an audio source.
